(19) United States
(12) Patent Application Publication
(10) Pub. No.: US 2007/0231669 A1
(43) Pub. Date: Oct. 4, 2007

(54) Design of fuel cell and electrolyzer for small volume, low cost and high efficiency

(76) Inventor: Chuni Lal Ghosh, Princeton Junction, NJ (US)

Correspondence Address: Chuni Lal Ghosh, 11 Glengarry Way, Princeton Junction, NJ, 08550, US

(21) Appl. No.: 11/726,650

(22) Filed: Mar. 22, 2007

Related U.S. Application Data
(60) Provisional application No. 60/786,088, filed on Mar. 27, 2006.

(51) Int. Cl. H01M 8/02; H01M 8/10; H01M 8/04; C25B 9/00

(52) U.S. Cl. 429/38; 429/35; 429/30; 429/26; 204/266

(57) ABSTRACT

An electrochemical fuel cell designed for a large electrochemical reaction surface area per unit volume for high power density and high efficiency. The fuel cell is designed for counter propagating reactants flow for uniform reaction rate over the whole reaction area. This design is scalable and a single cell can be built with output power level ranging from a few watts to several megawatts. The cell does not require bipolar plates and is lightweight. The design has been demonstrated with proton exchange membrane as an electrolyte for the electrochemical reaction, however, the design is adaptable for other types of fuels and fuel cells with other electrolytes including all types of polymer electrolytic fuel cells, alkaline fuel cells, phosphoric acid fuel cells, molten carbonate fuel cells, solid oxide fuel cells and all their subcategories as well. The fuel cell is adaptable for use as an electrolyzer as well.

### CROSS-REFERENCE TO RELATED APPLICATIONS

This application is related to the co-pending U.S. Provisional Patent Application No. 60/786,088 filed on Mar. 27, 2006, which is incorporated by reference herein in its entirety.

### STATEMENT REGARDING FEDERALLY SPONSORED RESEARCH OR DEVELOPMENT

Not Applicable.

### FIELD OF THE INVENTION

This invention is related to the field of electrochemical fuel cell for generating electricity by electrochemical reaction without combustion, and in particular to a new compact design for achieving high efficiency electricity generation. The invention also relates to an electrolyzer, a device that performs a complementary function of fuel cell, i.e., converting water, a byproduct of the fuel cell, into hydrogen fuel by application of an external electric current.

### BACKGROUND OF THE INVENTION

Fuel cell is a device to generate electricity by an electrochemical reaction of oxygen with a chemical fuel, such as hydrogen, methanol, ethanol, methane, etc. The end product of the reaction is mainly water. In a complementary reaction, water from the fuel cell is converted to hydrogen fuel by applying electricity to the cell from an external source in a device known as an Electrolyzer.

A conventional prior art fuel cell has a positive and a negative electrode namely, an anode and a cathode, a fluid fuel, a fluid reactant that electrochemically react to generate a potential difference between the anode and the cathode, thereby causing an electric current to flow through an external load, when connected between the two electrodes. The fluid fuel and the fluid reactant can both be gaseous, liquid or a combination thereof. For example, in one type of a conventional fuel cell hydrogen gas is the fuel and oxygen or air is the reactant gas, the oxygen in the air being a participant in the electrochemical reaction.

The fuel and the reactant separately flow on two sides of an electrolyte membrane, for example a proton exchange membrane (PEM) that transfers protons across the membrane. Protons are hydrogen atoms stripped of their electrons at the anode which then permeate through the membrane to electrochemically react with oxygen atoms to form water molecules on the other side of the membrane thereby creating a potential difference between the anode and the cathode of the fuel cell. A catalyst, such as platinum can be optionally applied on both sides of the electrolyte membrane which helps convert the hydrogen atoms into protons as well as helps reaction of protons with oxygen to form water.

Since it is combustion less process, the fuel cell technology offers tremendous promise in improving energy conversion efficiency from fuel to electricity, and reducing carbon dioxide emission from automobiles and other combustion processes. The other benefits of this energy conversion process are, absence of mechanical movement, low temperature operation, and noise reduction, (unlike, for example, a car engine which involves high temperature, large mechanical movement and noise generation).

While fuel cells are being developed for more than forty years and have gained a substantial degree of maturity and found applications in a large number of military and aerospace applications, their acceptance in commercial applications has been rather slow. More specifically, a major problem of prior art cells lies in scaling up for higher output power levels. In particular, the factors that limit high output power levels in the prior art designs are, limited fuel flow capacity, lower energy conversion efficiency, poor thermal and humidity management resulting in larger size and weight of the cells and higher cost.

Another disadvantage in scaling the output power of a prior art fuel cell, and particularly of a PEM fuel cell is that PEM is supported on bipolar plates. For a cell design using multiple PEMs, the number of bipolar plates to be used increase accordingly, thereby adding substantially to the size and weight of the cell. Therefore, scalability of the prior art design for higher output electrical power is extremely difficult and expensive.

Clearly, there is a need for a new design of electrochemical fuel cell that is particularly viable, easily scalable for high output power, and cost effective for large scale commercial applications.

In this invention, I propose a new design for a fuel cell that overcomes some of the major limitations of the prior art fuel cells mentioned earlier. A fuel cell designed and constructed according to the principles of this invention is, lightweight, easy to assemble, offers high energy conversion efficiency, and is easily scalable to higher output power levels. The design is applicable to fuel cells using different types of fuels. A further advantage of my design is its adaptability for electrolyzer application. In addition, and advantageously, the cost of my fuel cell is substantially lower as compared to a prior art device.

### SUMMARY OF THE INVENTION

One aspect of this new design is a spiral structure for a fuel cell. An exemplary embodiment using proton exchange membrane (PEM) fuel cell is presented to illustrate the design principles. The design is adaptable for fuel cells using conventional fluid fuels such as, hydrogen and a fluid reactant such as oxygen. However, the design is adaptable to other fuels, for example, all types of polymer electrolytic fuel cells (PEFC), alkaline fuel cells (AFC), phosphoric acid fuel cells (PAFC), molten carbonate fuel cells (MCFC) and solid oxide fuel cells (SOFC) and reactants such as air, or oxygen enriched liquids or gases. All the subcategories of these exemplary fuel cells are also possible. The same design is readily applicable to electrolyzers as well.

Another aspect of the my proposed design of a spiral structure PEM fuel cell is that it offers a self supporting mechanical structure for the cell as well as the PEM membrane. This is particularly significant in eliminating the bipolar plates that are used in prior art PEM fuel cells thereby reducing the size and weight, and making it readily adaptable for scaling up for high output power.

Another aspect of the spiral structure of the fuel cell is a very large surface area for a given volume of the fuel cell. By choosing the right radius of the spiral and spacing between layers of the spiral structure, a substantial gain in membrane surface area can be achieved compared to conventional fuel cells. A larger surface area for reaction translates into a larger current carrying capacity and power density. This aspect is additionally beneficial in scaling up for high output power.

Another aspect of the spiral structure fuel cell design is the counter propagating flow of the fuel (e.g. hydrogen) and the reactant (e.g. oxygen). By carefully selecting the flow rates of the fuel and reactant, the electrochemical process over the electrolyte membrane can be made self limiting to a certain reaction rate. Advantageously, because of the uniform electrochemical reaction rate in the entire cell, the current density per unit surface area of the electrochemical membrane would be uniform.

Another advantage of this design lies in efficient removal of heat that is generated during the electrochemical reaction, thereby offering improved scalability of the cell for higher output capacity. Heat removal capability is further enhanced by use of liquid coolants in the form of oxygen enriched liquids in the cathode channel or use of cooling tubes carrying liquids through the channels. Efficient humidity management is additionally accomplished by introducing hydrated hydrogen or moisture at multiple points along the fuel channel.

Another aspect of the spiral design of the fuel cell is that the design is readily adaptable for an electrolyzer where by applying an external current, hydrogen fuel is generated as a result of the reverse electrochemical reaction in the fuel cell.

### BRIEF DESCRIPTION OF THE FIGURES

Other aspects, features, and advantages of the present invention will become more clear from the following detailed description, the appended claims, and the accompanying drawings in which:

FIG. 1 is a cross section view of a spiral electrochemical fuel cell and electrolyzer showing fluid flow directions inside the spiral according to the principles of this invention.

FIG. 2 is a schematic of a limited 3-dimensional cross sectional view of a fuel cell showing fluid flow pattern inside the spiral electrochemical fuel cell and electrolyzer according to the principles of this invention.

FIG. 3 shows a 3-dimensional view of a fuel cell and electrolyzer constructed according to the principles of this invention.

FIG. 4 is a schematic view of an electrochemical fuel cell and electrolyzer in a flattened configuration designed according to the principles of this invention.

FIG. 5 is a schematic view showing conducting mesh electrode structure within a spiral fuel cell and electrolyzer according to the principles of this invention.

### DETAILED DESCRIPTION OF THE INVENTION

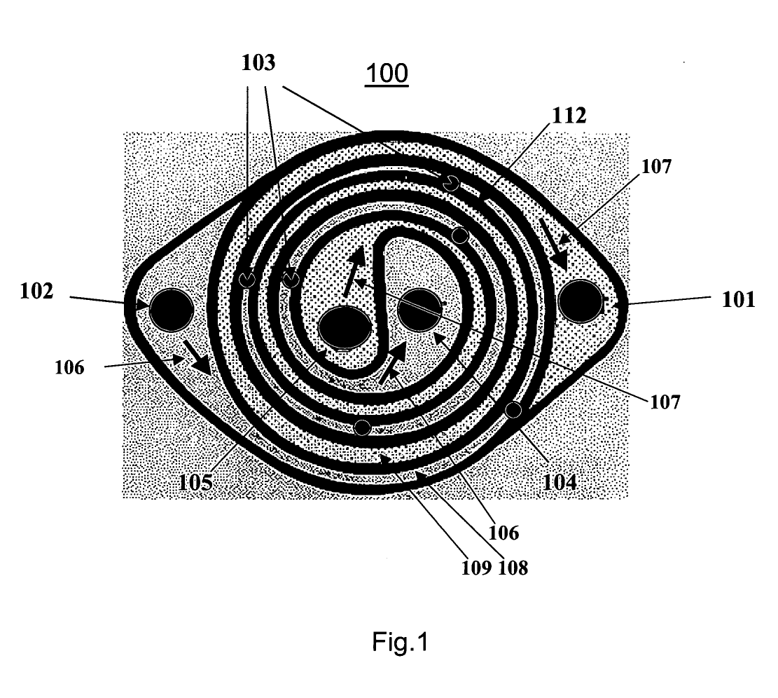

Principles of my invention first presented in the above mentioned related provisional application (Application No. 60/786,088 filed on Mar. 27, 2006), the content of which is incorporated by reference herein in its entirety, can be understood by the following description in light of the figures of the drawings. Various schematic views depicting different aspects of the design are shown in FIGS. 1-4. The electrochemical fuel cell according to the principles of the invention combines a spiral structure of a heat exchanger and principles with electrochemical cells technology namely, generation of electrical energy by an electrochemical reaction. Identical elements in the figures are represented by same reference numerals.

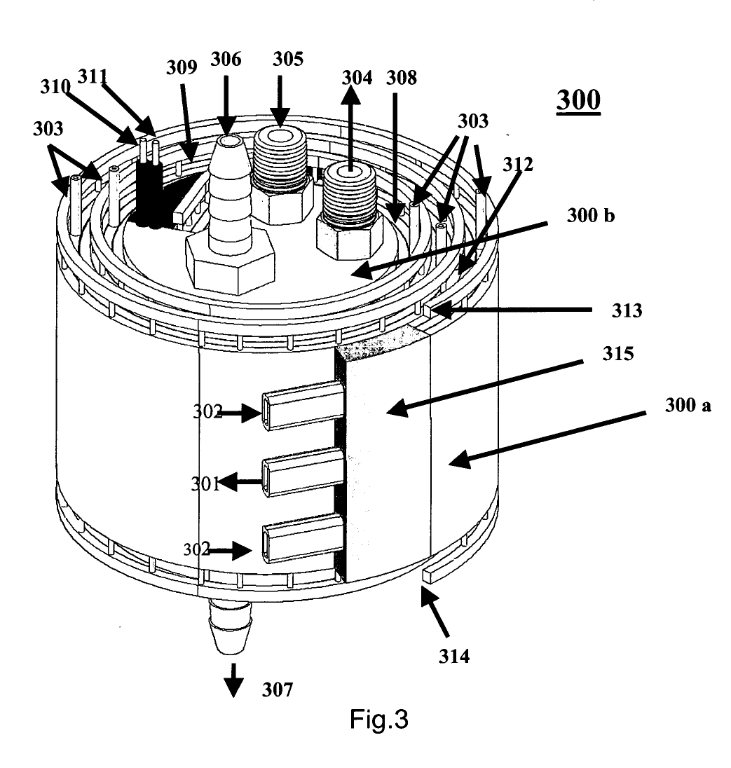

An embodiment of the invention described here is by way of example and is not meant to be limiting. Turning our attention first to FIG. 3, there it shows a schematic view of a fuel cell 300 designed and constructed according to the principles of the invention. In particular, in an embodiment described here, hydrogen is an exemplary fuel and air is an exemplary reactant gas. Throughout the description, I have used the term air and oxygen interchangeably with the implication that the oxygen in the air is the reactant gas that participates in the electrochemical reaction in the fuel cell. The design works well with liquids as well as gases.

In the example described here the fuel cell 300 has cylindrical body 300a, a top end 300b and a bottom end (not shown here) for providing physical support to the rest of elements of the cell. The top and the bottom ends of the cylindrical body are covered with circular surfaces that also provide support to a plurality of inlet and outlet ports connected to the center of the cylindrical member, the function of these inlet and outlet ports will be described later. The cylindrical body optionally has one or more openings along the vertical sides; the purpose of such openings is to be discussed later.

One aspect of my design is that the electrochemical reaction takes place in confined fluid channels within a self supporting spiral structure. In the exemplary fuel cell shown in FIG. 3 there are two fluid channels substantially of same size, represented as 308 and 309, the construction of the same is discussed next.

In the exemplary embodiment discussed here, the fluid channels are constructed from a first and a second flexible electrolyte membrane, each one of the membranes are substantially rectangular in shape such that each membrane has a top and bottom edge and two side ends that are the shorter ends of the rectangle. Each membrane further has a top and a bottom surface each. By way of example, the membranes in the embodiment shown here is Proton Exchange Membranes (PEM); however, other materials from this class of materials widely known in the art will work as well.

For constructing the channels, the rectangular membranes are arranged in a multi-layer stack comprising the first membrane, a first layer of a plurality of porous mesh materials overlying the entire top surface of the first membrane, the second membrane overlying the first layer of the porous mesh material, and a second layer of the plurality of the porous mesh materials of the porous mesh material overlying the entire top surface of the second membrane. In this example, the multi-layer has a top edge, a bottom edge and two opposing side ends, the side ends being the shorter ends of the stack.

The porous mesh material can be selected from a class of materials that are well known in the art for facilitating mixing of fluids without obstructing the flow of fluids. By way of example, the porous mesh materials in the embodiment shown in FIG. 3 include but are not limited to, stainless steel, carbon fiber, fiberglass, or a combination thereof. However, the porous mesh layer in immediate contact with the electrolyte membranes must be electrically conducting and, is preferably a metallic one for better electrical charge transfer across the membranes.

The multi-layer stack is connected to the cylindrical body 300a by inserting one short side end of the multi-layer stack in one of the one or more openings along the vertical sides of the cylindrical body and subsequently sealed, such that the sealed end is suitable for fluid flow from the respective inlet or outlet connected to the cylindrical body to the channels formed by the electrolyte membranes. The multi-layer stack with one end sealed to the cylindrical body is circumferentially rolled in a multiple turn spiral around the cylindrical body such that the bottom surface of the first membrane of the multi-layer stack is in immediate contact with the cylindrical body and the second layer of porous mesh material is rolled inside, thereby creating the self supporting spiral structure.

Hereafter, for the purpose of discussion, the one short end and the opposing short end of the multi-layer stack will be respectively referred to, as a first end and an opposing second end of the spiral structure. In addition, the circumferential top and bottom edges of the rolled spiral structure located respectively near the top and bottom ends of the cylindrical body will be referred to as the top and the bottom end of the spiral structure.

Although each turn within the spiral structure appears to be similar, those skilled in the art will appreciate that each alternate turn having the first layer of the plurality of porous mesh materials confined between the first and the second electrolyte membranes forms a first continuous channel, whereas each alternate ones of the adjacent turn having the second layer of the plurality of the porous mesh materials confined between the second and the first electrolyte membrane of the next turn forms a second continuous channel, respectively.

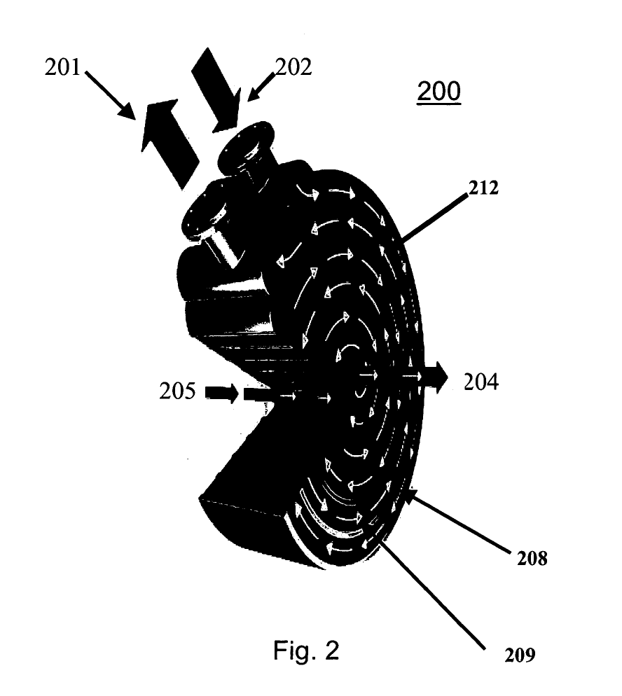

The layout of the two channels within the spiral structure can be better appreciated in the schematic partial cross sectional view shown in FIG. 2. There it shows an element 208 between two PEM layers 212 forming a first channel, whereas an adjacent element 209 between two PEM layers forms a second channel. The channels 208 and 209 are same as the first and the second continuous channels, respectively described in the previous paragraph and are equivalent of the fluid channels 308 and 309 as shown in the exemplary embodiment shown in FIG. 3. For the purpose of discussion, channels 308 and 309 will be referred to as a first fluid channel and a second fluid channel, respectively, hereafter.

The fluid channels 308 and 309 are isolated from each other by circumferentially sealing the top and the bottom ends of the spiral structure. Any of the methods widely known in the art for sealing electrolyte membranes may be selected, such methods including but are not limited to, pressure sealing, pressure sealing with a sealing material, sealing with adhesives that are chemically resistant to reactants in the channels. The second end of the spiral structure is sealed inside a rectangular block 315 along the second end, the other end of the block 315 having a plurality of inlet and outlet ports, connected to it. By way of example two inlet ports 302 and an outlet port 301 are shown in FIG. 3.

Referring again to FIG. 3, one end of the first fluid channel 308 is connected to the inlet port 302 located inside the block 315 whereas a second end of the first fluid channel 308 is connected inside the cylindrical body to an outlet port 304 located on the circular surface 300b at the top end of the cylindrical body. The inlet port 302, the first fluid channel 308 and the outlet port 304 form a first flow path for a fluid fuel. In this exemplary embodiment, gaseous hydrogen is used as the fuel.

In a similar way, an inlet port 305 located on the circular surface 300b at the top end of the cylindrical body which connects to an opening on the side surface, connected to the second fluid channel 309, in turn connected inside the block 315 to an outlet port 301 located on the rectangular block 315 forms a second flow path for a fluid reactant. In this exemplary embodiment oxygen, air, or a mixture of oxygen and air is used as the reactant gas. In this exemplary configuration, hydrogen and air flow in opposite directions thereby assisting in maintaining a steady reaction rate.

Those skilled in the art will appreciate that the outlet port 304 and the inlet port 305 may be located on the same or opposite circular surfaces at the top or the bottom ends of the cylindrical body with similar results. As long as, the two channels 308 and 309 have their inlet ports and the outlet ports located on the opposing ends of the spiral structure, the fluid flow direction in the two channels are maintained to be opposite to each other. Those skilled in the art will appreciate that the two channels can be easily interchanged as long as the flow of the two fluids is maintained in opposite directions.

In the exemplary configuration of the PEM fuel cell shown in FIG. 3, the channel 308 on one side of the PEM layer confining hydrogen acts as an anode and the channel 309 on the other side of the PEM layer confining air acts as a cathode. The porous mesh materials in immediate contact with the PEM layers also carry the electrical current through the fuel cell and may optionally be coated with noble metals like gold or platinum to reduce the contact resistivity. Two electrical ports 310 and 311 provide electrical connections to the anode and the cathode sides of the membrane, respectively. By way of example, the electrodes are shown to be located on the same side of the cylindrical body in FIG. 3; however, this is not the only choice. Those skilled in the art will appreciate that other configuration of electrodes will work as well. An external electrical load may be connected between the anode 310 and the cathode 311 for delivery of electrical power to the external load.

A cooling liquid is optionally provided for efficient transfer of heat generated in the electrochemical reaction between the fuel and the reactant gas. By way of an example, a cooling tube connected between an inlet port 306 and an outlet port 307, respectively, shown in FIG. 3 to be located on the end surfaces at the top and the bottom ends of the cylindrical body 300a, forms a circulation path for the cooling fluid. In this configuration, the cooling is provided to the cylindrical body. The location of the inlet and outlet ports shown here are by way of example; any other location for the cooling ports providing same functionality will work as well.

Optionally, additional cooling tubes or thin capillaries capable of carrying cooling fluids in the channels 308 and 309 connected to an additional inlet port 313 is provided for supplying additional cooling liquid for circulating the same in the channels for efficient heat removal/transfer. It may be provided in the air channel or in the hydrogen channel, or in both. The cooling liquid entering the inlet port 313 exits from a corresponding outlet port 314. The cooling tubes or thin capillaries function substantially similar to a heat exchanger. Alternatively, cooling fluid enriched with oxygen by dissolving substantially large amount of oxygen in the cooling fluid may be optionally used as the reactant fluid instead of air or oxygen. The oxygen dissolved in the liquid cooling fluid participates in the electrochemical reaction.

At least one or more optional inlet port 303 is provided for introducing humidified hydrogen or moisture if necessary, more specifically, if there is humidity depletion in the cell during high output power operation. Advantageously, with additional insertion points for hydrated hydrogen or moisture and with provision for liquid cooling this fuel cell design can be readily adapted for high electric output power.

Further advantages of the fuel cell design described earlier in reference with FIG. 3 will be apparent to those skilled in the art by details to be described now in reference with FIGS. 1, wherein a view of fluid flow pattern in the exemplary embodiment of the PEM fuel cell is shown. Referring now to FIG. 1, there it shows by way of example, a hydrogen channel 108 and an air/oxygen channel 109 located on the two opposite sides of a proton exchange membrane (PEM) 112. Hydrogen enters the channel 108 through an inlet 102 and exits the channel through an outlet 104, whereas air enters the channel 109 through an inlet 105 and exits the channel through an outlet 101.

Notably, the respective inlet ports and outlet ports are physically located at the opposite ends and it is clear from FIG. 1 that the flow of hydrogen is in a counter-propagating direction as compared to the flow of air. For example, while hydrogen flows in a direction 106, air flows in a direction 107 that is counter propagating to the hydrogen flow inside the cell. The flow directions of hydrogen and oxygen are interchangeable as long as the direction of flow in the two channels for hydrogen and oxygen are opposite to each other.

One advantage of selecting opposite flow direction of hydrogen and air is that the electrochemical reaction is self limiting at every point of the electrolyte membrane, namely PEM 112. The following discussion further illustrates this aspect of the invention. In an electrochemical reaction, the reaction rate is controlled by the availability of the reactants in the flow channels participating in the reaction at every point of the PEM surface through which the electrochemical reaction takes place. This point will be further illustrated by considering the fluid flow pattern of the fuel and the reactant gas shown in FIG. 1.

In particular, near the hydrogen inlet port 102 to the channel 108, although there is plenty of hydrogen available, the concentration of oxygen is limited because as air flows through the channel the oxygen in the air is depleted by participation in the electrochemical reaction. Accordingly, concentration of oxygen in the air near the inlet port 102 is limited and the reaction rate at this end is controlled by the concentration of oxygen in the air. Following the same logic, it is apparent that the reaction rate at the air inlet port 105 will be therefore controlled by the lower concentration of hydrogen near the outlet port 104 of hydrogen because of hydrogen depletion due to electrochemical reaction along the channel.

Therefore, those skilled in the art will appreciate that the high availability of one gas at a certain point along the surface of the PEM does not necessarily make the reaction faster at that point. Therefore, by carefully selecting the flow rates of the fuel and the reactant gas, the electrochemical reaction rate can be controlled at every point along the spiral structure. The reaction becomes self limiting and the reaction rate can be maintained equal at all points all along the spiral structure offering substantial benefits in efficiency and thermal management.

According to another aspect of the invention this new design of fuel cell by virtue of a spiral structure offers higher surface area for reaction because the surface to volume ratio of the cell structure is substantially high. This particular aspect has several major advantages that will be apparent to those skilled in the art from the following discussion.

For a given volume of the fuel cell, a higher surface area will result in higher current capacity because the current density per unit volume of the cell will be significantly higher as compared to a cell with same volume but a lower surface area. A higher current density translates into higher power density deliverable to an external load. Therefore, a fuel cell constructed according to the principles of this invention will be able to deliver much higher output power as compared to a prior art cell for the same cell volume. Those skilled in the art can very well appreciate the output power scalability advantage.

In addition, a higher surface to volume ratio for a given cell volume also offers the ability to run the cell at higher efficiency by running it at lower than maximum allowable current density near the surface of the electrolyte membrane where the conversion efficiency is much higher.

Another aspect of this design is that the PEM layers are self supported, therefore they do not require bipolar plates to support the structure unlike the prior art fuel cells. This is a major advantage in scaling up for higher output power for a spiral structure fuel cell without substantially increasing the weight of the fuel cell according to the principles of this invention.

Another aspect of my design of fuel cell is its efficient thermal and water management. Due to the meshes inside the channels, the reaction gases flowing through the channels are mixed very well. The channels further have optional cooling tubes or thin capillaries embedded therein for circulating liquid coolants through them. These two design aspects together facilitate efficient heat transfer/exchange thereby lowering the operating temperature of the cell. This is an advantage particularly for high output power operation of the fuel cell.

Additionally, provisions for oxygen rich coolant to replace air as a reactant gas, and introduction of humidified fuel gas or moisture at multiple points along the spiral for humidity replenishment in the fuel gas, offer additional dimension to this design for improved performance and higher output power operation.

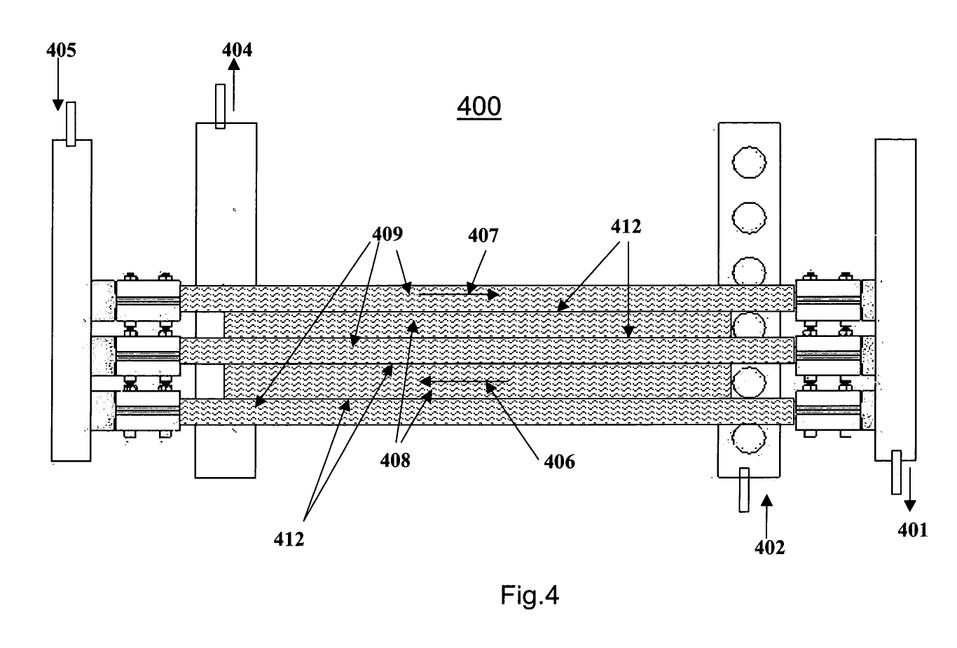

A second embodiment of this fuel cell design is schematically shown in FIG. 4. While this design is similar to the spiral design described earlier in reference with FIGS. 1-3, it differs only in geometric aspects. More specifically, all the design considerations in this embodiment are similar except that in this case, all the elements of the spiral design are configured in a flat geometry. It can be readily appreciated by those skilled in the art that this configuration also has substantially the same advantages as the spiral design.

Accordingly, and as shown in FIG. 4, this embodiment of fuel cell comprises a set of multi-layer stacks, each said stack has substantially similar construction as described earlier in reference with the spiral structure cell shown in FIG. 3. More specifically, each multi-layer stack comprises a first electrolyte membrane, a first layer of a plurality of porous mesh material overlaying the entire top surface of the first membrane across it, a second electrolyte membrane overlying the first layer of the porous mesh materials, and a second layer of the plurality of the porous mesh material overlaying the entire top surface of the second membrane.

Those skilled in the art will appreciate that by repeating this order in stacking several of said multi-layer stacks, multiple channels are created such that each channel has a layer of the porous mesh materials confined between electrolyte membranes on either side of said layer of porous mesh materials, as shown in FIG. 4. However, care must be taken that the second layer of the porous mesh materials in the last multi-layer stack in stacking said multi-layer stacks must be covered with an additional electrolyte membrane such that all the channels in the stack have a layer of porous mesh materials confined between electrolyte membranes on either side of said layer of porous mesh materials.

By way of example, the electrolyte membranes are PEM represented by 412 in FIG. 4. As in the case of spiral structure fuel cell, the PEMs 412 in this configuration as well are supported on the layers of porous mesh material in the stack. Therefore, the PEMs do not require bipolar plates for support, thereby reducing the weight of the fuel cell. All the sides of the multiple channels created by stacking said multi-layer stacks are sealed using sealing methods described earlier in reference with the spiral structure.

Each channel in the stack has an inlet port and an outlet port respectively. The inlet ports of the alternate ones of these channels represented as 408 in FIG. 4, are connected together, and are in turn connected to a common inlet port 402, and in a substantially similar fashion, all the outlet ports of the channels represented as 408 in FIG. 4, are connected together and are in turn connected to a common outlet port 404. Similarly, the inlet ports of channels adjacent to each ones of said alternate ones of the channels, represented as 409 in FIG. 4 are connected together, and are in turn connected to a common inlet port 405, and in a substantially similar fashion, all the outlet ports of the channels represented as 409 in FIG. 4, are connected together and are in turn connected to a common outlet port 401.

Those skilled in the art will appreciate that the channels represented as 408 connected between the inlet port 402 and the outlet port 404 forms a first fluid channel for circulating a fluid fuel, and the channels represented as 409 connected between the inlet port 405 and the outlet port 401 forms a second fluid channel for circulating a fluid reactant, substantially similar to the first and the second fluid channels 308 and 309, respectively, as described earlier in reference with the spiral structure fuel cell. By way of example, the fluid fuel in channel 408 is gaseous hydrogen and the fluid reactant in channel 409 is air in this embodiment of the PEM fuel cell.

As can be seen, the PEM layers separate hydrogen from air as well as support the electrochemical reaction. Furthermore, hydrogen in channel 408 and air in channel 409 flow in opposite directions, as indicated by flow directions 406 and 407, respectively, thereby offering all the advantages of the spiral structure fuel cell described earlier. Those skilled in the art will readily appreciate this alternative configuration has substantially the same advantages of the spiral structure fuel cell namely, uniform and self limiting reaction rate at each point across the PEM layers and scalability for high output power. In addition, this design is particularly useful where small foot print is required, for example as a portable power source for small hand held devices or in such cases where geometrical consideration favors a non-cylindrical design.

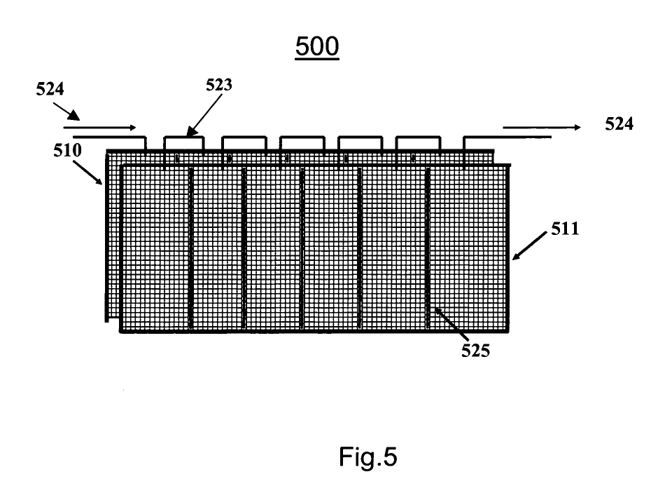

One aspect of design of my fuel cell lies in a special design of electrodes, particularly for high power applications as illustrated in FIG. 5. For delivering of high power it is important to have high voltage at lower current. Accordingly and as shown in FIG. 5, there it shows a mesh structure for an anode 510 which is in the hydrogen flow side and a mesh structure for a cathode 511 in the air flow side. The mesh section electrodes are segmented and connected in series by wires 523 in a fashion similar to connecting multiple batteries in series to obtain higher voltage (positive side of one connecting to the negative to the other, anode to cathode and cathode to anode and so on). 524 show the current flow direction.

The individual mesh sections on each side are mechanically connected to each other with insulating separators 525 in between on both sides. As an example, the insulating material for the separator can be selected from a wide variety of materials such as Teflon or neoprene known to those skilled in the art. Alternatively, perforated sheets of insulating materials can be used instead.

In another embodiment of the invention, the fuel cell described in reference with FIG. 3 and FIG. 4 can be adapted for an electrolyzer. More specifically, an electrolyzer generates hydrogen by electrolysis of water. Referring back to FIG. 3, and by way of example, the fuel cell shown therein can be used as an electrolyzer by introducing water through the inlet port 305 that flows in the channel 309 and exits through the outlet port 301. On the other hand, an inert gas, hydrogen or a mixture of an inert gas and hydrogen is introduced through the inlet port 302 that flows in the channel 308. An external electric current applied between the electrodes 310 and 311 electrolyzes water in an electrochemical reaction thereby generating hydrogen. The hydrogen so generated flows out of the channel 308 through the outlet port 304.

The hydrogen generated as a result of electrochemical reaction is added to the hydrogen or inert gas introduced in the first channel. Those skilled in the art will appreciate that the electrolyzer described herein has all the advantages of the spiral fuel cell, including high surface to volume ratio, uniform and self limiting reaction rate over the entire length of the PEM membrane and scalability for high output of hydrogen from a single cell.

In addition, and by way of example, a PEM fuel cell designed and constructed according to the principles of the invention can be operated at temperatures above 80° C. at which the carbon monoxide poisoning is almost eliminated giving much higher reliability and still maintaining much higher output power density than can be obtained from a prior art cells.

Notably, a fuel cell and an electrolyzer according to the principles of this invention can be adapted for other electrolytic fuel cells including, but not limited to all types of polymer electrolytic fuel cells (PEFC), alkaline fuel cells (AFC), phosphoric acid fuel cells (PAFC), molten carbonate fuel cells (MCFC) and solid oxide fuel cells (SOFC) and all their subcategories as well.

The electrochemical fuel cell constructed according to the principles of the invention can be further enclosed in a protective enclosure commensurate with the geometry and the size of the cell to prevent physical damage to the cell. Such protective enclosure may serve additional purpose of protecting the elements of the cell from environmental degradation.

The drawings and designs of the embodiments shown and described here are only meant to exemplary and should not be construed to be limiting. Those skilled in the art will appreciate that the design principles described here can be adapted for other fuel cells using materials other than those described in this invention.

What is claimed is:

1. An electrochemical fuel cell comprising:
a cylindrical member with a top end, and a bottom end, each end optionally having a plurality of inlet ports and a plurality of outlet ports connected to the body of the cylindrical member, and the cylindrical member further including at least two vertical opening along the side surface;
a spiral member, said spiral member constructed from a multi-layer stack having top and bottom edges, a first and a second opposing ends,
wherein said first end is sealably attached to said cylindrical member, said multi-layer stack further rolled circumferentially around said cylindrical member in multiple turns,
and wherein said second end is sealably terminated in one or more connectors, said connectors for connecting at least one each inlet port and at least one each outlet port;
the spiral member further including:
a sealed first fluid channel connected between a first inlet port of the at least one inlet port connected to the one or more connectors and a first outlet port of the plurality of outlet ports connected to the cylindrical member thereby forming a first fluid path for circulating a first fluid connected to the said first inlet port,
a second sealed fluid channel connected between a first inlet port of the plurality of inlet ports connected to the cylindrical member and a first outlet port of the at least one outlet port connected to said one or more connectors thereby forming a second fluid path for circulating a second fluid connected to said second inlet port,
wherein the first and the second fluid circulate in opposite directions with respect to each other within said spiral member;
a first and a second electrode, electrically connected respectively to the first and the second fluid channels, and wherein said electrodes further are optionally attached to the top end of the cylindrical member,
such that an electrochemical reaction between the first fluid and the second fluid circulating respectively, in the first channel and the second channel in the fuel cell generates a potential difference between the first and the second electrode.

2. The electrochemical fuel cell of claim 1, wherein the multi-layer stack forming the spiral member further includes:
a first electrolyte membrane;
a first layer of a plurality of porous mesh materials overlying the entire top surface of the first membrane;
a second electrolyte membrane of substantially the same size and shape of the first membrane, said second membrane overlying the first layer of the plurality of the porous mesh materials; and
a second layer of the plurality of porous mesh material overlying the entire top surface of the second membrane.

3. The electrochemical fuel cell of claim 2, wherein the first and the second electrolyte membranes are Proton Exchange Membranes.

4. The electrochemical cell of claim 2, wherein the porous mesh materials include a class of materials that promote mixing of fluid without obstructing the fluid flow.

5. The electrochemical fuel cell of claim 2, wherein the layers of porous mesh material adjacent to, and in electrical contact with the electrolyte membranes are electrically conducting.

6. The electrochemical fuel cell of claim 2, wherein the porous mesh material adjacent to, and in electrical contact with the electrolyte membranes is optionally coated with a noble metal for enhancing electrical conductivity.

7. The electrochemical fuel cell of claim 1, wherein the first electrode in electrical contact with the first fluid channel is an anode and the second electrode in electrical contact with the second fluid channel is a cathode.

8. The electrochemical fuel cell of claim 1, wherein the first fluid is a gaseous fuel.

9. The electrochemical fuel cell of claim 8, wherein the gaseous fuel is hydrogen.

10. The electrochemical fuel cell of claim 1, wherein the first fluid is a liquid fuel.

11. The electrochemical fuel cell of claim 1, wherein the second fluid is a gaseous reactant.

12. The electrochemical fuel cell of claim 11, wherein the gaseous reactant is selected from a group consisting of oxygen, air, and a mixture of oxygen and air

13. The electrochemical fuel cell of claim 1, wherein the second fluid is a liquid reactant.

14. The electrochemical fuel cell of claim 13, wherein the second fluid is oxygen enriched cooling fluid.

15. The electrochemical fuel cell of claim 1, wherein a cooling tube is optionally connected between a second inlet port of the plurality of inlet ports connected to the cylindrical member and a second outlet port of the plurality of outlet ports connected to the cylindrical member for circulating a cooling liquid through the cylindrical member.

16. The electrochemical fuel cell of claim 1, wherein optional cooling tubes connected to respective inlet and outlet ports, are embedded within the first and the second channels for circulating a cooling liquid for cooling the channels, wherein the optional cooling tubes in the first channel are independent of the optional cooling tubes in the second channel.

17. The electrochemical fuel cell of claim 16, wherein the optional cooling tubes are thin capillaries.

18. The electrochemical fuel cell of claim 1, wherein the first channel optionally has additional inlet ports, said additional inlet ports for introducing fluids selected from a group consisting of hydrated hydrogen and moisture.

19. The electrochemical fuel cell of claim 1 wherein the electrodes further comprising a segmented mesh structure externally connected in series with wires for delivering higher voltage and lower current to an external load connected between the electrodes.

20. The electrochemical fuel cell of claim 1, wherein the fuel cell is enclosed in an outer shell for protecting the fuel cell from environmental elements.

21. The electrochemical fuel cell of claim 1, wherein the first and the second channels are interchangeable.

22. The electrochemical fuel cell of claim 21, wherein said fuel cell is adaptable for use as an electrolyzer for generating hydrogen, wherein
the first fluid is circulating in the second fluid channel, wherein the first fluid is water,
the second fluid is circulating in the first fluid channel, wherein the second fluid is selected from a group consisting of an inert gas and hydrogen,
an external voltage applied between the anode and the cathode for passing an electric current in the channels,
such that the electrical current passing through the water in the second channel results in a reverse electrochemical reaction in the fuel cell thereby, generating hydrogen that flows out of the first channel.

23. The electrolyzer as in claim 22, wherein the first and second channels are interchangeable.

24. An electrochemical fuel cell comprising:
a plurality of channels stacked together, each one of said channels having respective inlet and outlet ports, wherein all alternate ones of said channels in the stack are connected together to form a first fluid channel, and wherein the remaining channels adjacent to each one of the alternate ones of said channels in the stack are connected together to form a second fluid channel;
a first inlet port and a first outlet port connected to the first fluid channel respectively at the opposing ends, forming a first fluid path for circulating a first fluid connected to said first inlet port;
a second inlet port and a second outlet port connected to the second fluid channel respectively at the opposing ends, forming a second fluid path for circulating a second fluid connected to said second inlet port, wherein the second fluid circulates in a direction opposite to the direction of said first fluid circulation; and
a first and a second electrode in electrical contact with the first fluid in the first channel and the second fluid in the second channel, respectively, such that an electrochemical reaction between the first and the second fluid in the cell generates a potential difference between the electrodes.

25. The electrochemical fuel cell of claim 24, wherein said plurality of channels further including a stack of:
at least two electrolyte membranes, each one of said membranes of substantially the same shape and size; and
one or more layers of a plurality of porous mesh materials,
wherein each one of said electrolyte membrane has a layer of one of the layers of plurality of porous mesh materials adjacent to it, and
wherein each one layer of the plurality of the porous mesh materials has a electrolyte membrane on either side of said layer of the plurality of porous mesh materials, thereby forming one channel of said plurality of channels stacked together.

26. The electrochemical fuel cell of claim 25, wherein the electrolyte membranes are Proton Exchange Membranes.

27. The electrochemical cell of claim 25, wherein the porous mesh materials include a class of materials that promote mixing of fluid without obstructing the fluid flow.

28. The electrochemical fuel cell of claim 25, wherein the layers of porous mesh material adjacent to, and in electrical contact with the electrolyte membranes are electrically conducting.

29. The electrochemical fuel cell of claim 28, wherein the porous mesh material adjacent to, and in electrical contact with the electrolyte membranes is optionally coated with a noble metal for enhancing electrical conductivity.

30. The electrochemical fuel cell of claim 24, wherein the first electrode in electrical contact with the first fluid channel is an anode and the second electrode in electrical contact with the second channel is a cathode.

31. The electrochemical fuel cell of claim 24, wherein the first fluid is a gaseous fuel.

32. The electrochemical fuel cell of claim 31, wherein the gaseous fuel is hydrogen.

33. The electrochemical fuel cell of claim 24, wherein the first fluid is a liquid fuel.

34. The electrochemical fuel cell of claim 24, wherein the second fluid is a gaseous reactant.

35. The electrochemical fuel cell of claim 34, wherein the gaseous reactant is selected from a group consisting of oxygen, air, and a mixture of oxygen and air.

36. The electrochemical fuel cell of claim 24, wherein the second fluid is a liquid reactant.

37. The electrochemical fuel cell of claim 36, wherein the second fluid is oxygen enriched cooling fluid.

38. The electrochemical fuel cell of claim 24, wherein optional cooling tubes connected to respective inlet and outlet ports, are embedded within the first and the second channels for circulating a cooling liquid for cooling the channels, wherein said cooling tubes in the first set of channels are independent of said cooling tubes in the second set of channels.

39. The electrochemical fuel cell of claim 38, wherein the optional cooling tubes are thin capillaries.

40. The electrochemical fuel cell of claim 24, wherein the first channel optionally has additional inlet ports, said additional inlet ports for introducing fluids selected from a group consisting of hydrated hydrogen and moisture.

41. The electrochemical fuel cell of claim 24, wherein the electrodes further comprising a segmented mesh structure are externally connected in series with wires for delivering high output power.

42. The electrochemical fuel cell of claim 24, wherein the first and the second fluid channels are interchangeable

43. The electrochemical fuel cell of claim 42, wherein said fuel cell is adaptable for use as an electrolyzer for generating hydrogen by electrolysis of water, wherein
the first fluid circulates in said second fluid channel, wherein the first fluid is water,
the second fluid circulates in the first fluid channel, wherein the second fluid is selected from a group consisting of an inert gas and hydrogen,
an external voltage applied between the anode and the cathode for passing an electric current in the channels,
such that the electrical current passing through the water in the second channel results in a reverse electrochemical reaction in the cell, thereby generating hydrogen that flows out of the first channel.

44. A method of electrochemical fuel cell, said method comprising the steps of:
supporting, a multiple layer spiral member including a first fluid channel and an adjacent second fluid channel,
connecting each one of said fluid channels between a respective one of an inlet port and a respective one of an outlet port, thereby forming a first and a second fluid circulation path in the first and the second channel, respectively,
connecting a first fluid to the respective inlet port of the first channel and a second fluid to the respective inlet port of the second channel,
circulating, within the spiral member, the first fluid in the first channel and the second fluid in the second channel, wherein the flow direction of the first fluid is opposite to the flow direction of the second fluid in the respective fluid channels, and
generating, as a result of an electrochemical reaction between the first and the second fluid, a potential difference between a first electrode, electrically connected to the first channel, and a second electrode, electrically connected to the second channel.

45. The method of claim 44, wherein said step of supporting the fluid channels further includes a step of:
arranging, in a multi-layer stack including:
a first electrolyte membrane having a top and bottom surfaces,
a first layer of a plurality of porous mesh materials overlying the entire top surface of the first membrane,
a second electrolyte membrane, said membrane of substantially the same size and shape as the first membrane having a top and bottom surfaces, overlying the entire first layer of the plurality of the porous mesh materials,
a second layer of the plurality of porous mesh materials overlying the entire top surface of the second membrane,
rolling, with the second layer of the plurality of the porous mesh materials inwards, the multi-layer stack into said spiral member having multiple turns, wherein each alternate ones of the turns together form a first continuous fluid channel, and the remaining alternate ones of the turns together form a second continuous fluid channel, such that the first fluid channel is always adjacent to the second fluid channel within the spiral member.

46. The method of claim 45, wherein said step of arranging the multi-layer stack includes using Proton Exchange Membranes.

47. The method of claim 44, wherein said step of circulating includes a step of:
circulating, in the first channel, gaseous hydrogen, and
circulating, in the second channel, a gas selected from a group consisting of air, oxygen, and a mixture of air and oxygen.

48. The method of claim 44, wherein said step of circulating further includes a step of:
circulating, in the second channel, water, and
circulating, in the first channel, a gas selected from a group consisting of an inert gas and hydrogen,
applying a voltage externally between a first electrode electrically connected to the first channel and a second electrode electrically connected to the second channel, and
generating, by a reverse electrochemical reaction in the cell, gaseous hydrogen, such that the electrochemical fuel cell is adaptable to work as an electrolyzer.
